(19) United States
(12) Patent Application Publication
(10) Pub. No.: US 2021/0310919 A1
(43) Pub. Date: Oct. 7, 2021

(54) System & Method for Strain-Controlled Thermo-Mechanical Fatigue Testing

(71) Applicant: Michael A. McGaw, Fairview Park, OH (US)

(72) Inventor: Michael A. McGaw, Fairview Park, OH (US)

(21) Appl. No.: 14/256,958

(22) Filed: Apr. 19, 2014

(51) Int. Cl. G01N 3/34

(52) U.S. Cl. CPC G01N 3/34; G01N 2203/0647; G01N 2203/0694

(57) ABSTRACT

An adjustable induction heating coil and cooling plenum assembly for use in a strain-controlled thermo-mechanical fatigue test of a specimen, wherein the specimen is suspended in a load frame under a constant tensile force, comprising: a heating coil comprised of a plurality of windings of a metal tube having a first end and a second end, comprised of metallic tubing suitable for connection to a radio frequency induction furnace; a moveable stage slideably connected to a stage assembly comprising: a dielectric block having at least one elongated slot; a connection block slideably connected to the dielectric, having a hollow conduit through the heating coil connection block and a connection fitting fixedly attached at first and second ends of the hollow conduit; and a cooling plenum assembly comprising: a relatively thin, flat toroid-like shaped plenum having a cap fixedly connected to a body, a hollow central bore, and a perimeter sidewall surrounding the hollow central bore; a first perimeter shape of the hollow central bore substantially conforms to a second perimeter shape of the specimen; a continuous hollow channel within said perimeter sidewall; a continuous opening of between 0.002 and 0.004 inches between the cap and the body on an interior side of said perimeter sidewall.

### RELATED APPLICATION

This application claims priority to Provisional Application Ser. No. 61/813,963, filed on Apr. 19, 2013, the entire disclosure of which is incorporated herein by reference.

### BACKGROUND OF THE INVENTION

### Field of the Invention

The operating conditions of many structures are inherently thermo-mechanical in nature, the change in temperature with time results in thermally induced stresses due to temperature gradients over the component during heating and cooling as well as thermal expansion mismatch between different materials in components and systems. This complexity is exacerbated for structural components that experience mechanically induced stress superimposed over thermally induced stress.

Thermo-mechanical testing is considerably more complex than isothermal mechanical testing. A major difficulty arises in controlling the temperature as a function of time so that thermal gradients on the test specimen are sufficiently small to guarantee continuum volume assumptions, and so that accurate and repeatable mechanical strains may be applied and controlled. In actual practice, because it is so difficult to achieve adequate control over gradients and heat up and cool down rates, the cycle times are slowed and become quite long, on the order of several minutes per heat up and cool down cycle.

### Description of the Problems

Currently two major problems arise in the conduct of thermo-mechanical fatigue (hereinafter “TMF”) testing. They can be categorized as follows: (1) thermal management, and (2) length of test cycle time.

Thermal Management

Thermal gradients and their management play an important role in ensuring that continuum volume element assumptions—uniform volume, temperature and stress—hold true for the test. The main concerns are axial and radial gradients. Axial thermal gradients that vary during thermal cycling induce forces and unintentional strains on the test specimen. Radial thermal gradients that vary during thermal cycling induce cyclic internal stresses that cannot be measured axially. The photo of the specimen 1020 on the right in FIG. 1 shows an example of the geometric instability that can result from inadequate control of thermal gradients. When this occurs, continuum volume assumptions are no longer valid.

There are many adjustments that must be made in order to obtain satisfactory dynamic thermal gradients: very often, the experimentalist is faced with the prospect of accommodating gradients at one end of the temperature cycle at the expense of the other end, and must adjust the coils to center the difference, accepting the gradients as they are present. This is due to a variety of factors, including: differences in heat conduction at either specimen end, differences in coil geometry at either specimen end, and the change in absolute position of the test section of the specimen as a function of temperature due to thermal expansion. Additional movement is experienced under the further application of mechanical strain.

Another problem arises from the movement of the radio frequency heating coils, which heat the specimen, with the rate of power application. A rapid change in flux often results in movement of the coil assembly. If the leads from the furnace/work station are long, and are part of the coil itself, considerable coil deflection occurs relative to the test section with high rates of power application.

TMF Cycle Time Optimization/Reduction

The need to keep thermal gradients minimized has the consequential effect of generally lengthening TMF heating/cooling cycle times. The actual cycle time is largely dominated by the cooling rate achievable on a given test apparatus.

### Prior Art

A typical prior art testing fixture is shown in FIG. 2, and a more advanced version is shown in FIG. 3. Developed by Ellis, et al., and used by Castelli, FIG. 4 provides a detailed isometric of the heating coil fixture in another prior art device. Advantages of this fixture include: (1) the ability to tailor upper, center and lower coil geometries independently of one another; (2) the ability to swing the coil sections out of the way, to facilitate specimen loading/unloading; and (3) the ability to precisely position each coil along the axis of the specimen, providing concentricity adjustment as needed.

Each coil 1001 is mounted on a separate adjustment assembly 1002, which is electrically insulated from the load frame by a dielectric block 1003, each assembly 1002 giving axial and concentricity control. Setscrews 1004 are used to lock a given assembly in place once a workable configuration is found. All coils 1001 are electrically in series, and act as one coil, as seen by the RF furnace. This fixture has been successfully employed in TMF testing.

A prior art improvement involving a cooling chamber device, as shown in FIG. 5, facilitates active cooling of the specimen, thus shortening test cycle time. The principle features of this cooling system are: (1) the cooling air impinges on the test specimen 1005 through an array of axial air jets (not shown) at 90 degrees around the specimen 1005 from a constant pressure source; (2) the array of axial jets provides relatively even specimen cooling; (3) the heating coil 1008, inside the cooling chamber 1006, does not interfere with air flow; and (4) an access port (not shown) allows an extensometer to be positioned out of the air flow.

This prior art device still presents a number of problems: (1) the device is quite noisy during operation due to the large flows of air; (2) despite the access port, the cooling chamber still presents an obstacle to access by the extensometer; (3) mounting the chamber itself is difficult and thus time-consuming; (4) the use of nozzles to direct cooling air at the specimen produces poor gradient performance; (5) the maximum temperature capability is too low for duplicating appropriate turbine airfoil temperatures; (6) it is very difficult to adjust the coil positions since they are located inside the chamber, and (7) the device is not easily adaptable to an alternate load frame and specimen mounting configuration that has a requirement of periodic specimen surface inspection during the test.

### BRIEF DESCRIPTION OF THE INVENTION

A thermo-mechanical testing apparatus is disclosed that improves existing thermo-mechanical testing techniques in numerous ways, including: (1) one embodiment facilitates the controlled movement of each coil section separately, thus providing the ability to actively alter the axial position of the RF induction coil with precision and repeatability; (2) another embodiment integrates moveable coil heating and active cooling controls; (3) another embodiment refines the coil device design by providing galvanic isolation from the load frame to minimize the possibility of RF arcing; (4) another embodiment may incorporate an extensometer into the cooling device design; (5) another embodiment improves the fixture design by enabling appropriate adjustment of the cooling device with respect to the test specimen, providing an alternate cooling approach that improves cooling and gradient control; (6) this embodiment radically reduces the operating noise level; (7) all embodiments dramatically improve thermal management and cycle time optimization; and (8) all embodiments enable line of sight access to the specimen test section for inspection during test cycling.

In one embodiment according to the invention, an improved adjustable heating coil support assembly for use in strain-controlled, thermo-mechanical fatigue testing of a specimen is disclosed. The assembly comprises a heating coil fixedly mounted to a moveable stage assembly that is slideably mounted to a slide affixed parallel to the axis of the specimen, and an individual stepper motor mounted to a ball-screw stage affixed to the moveable stage assembly, together with suitable controls. This assembly provides the ability to alter the axial position of the RF induction coil by controlled movement with precision and repeatability. The assembly can support up to a three-zone coil configuration (upper and lower coils, plus a middle coil).

In another embodiment according to the invention, an improved cooling apparatus for use in strain-controlled, thermo-mechanical fatigue testing of a specimen is disclosed. The apparatus comprises: a toroid-like shaped plenum comprised of two fastened, spaced apart components, a body and a cap, having a continuous sidewall around a hollow central bore, wherein the sidewall includes a continuous hollow channel running throughout the periphery of the cooling plenum, said cooling plenum surrounding the specimen, which is suspended within the hollow central bore of the cooling plenum at approximately its central axis, at a section along the specimen's length, wherein the interior side of the plenum sidewall is shaped so as to substantially conform to the cross-sectional shape of the specimen at the section and, in the direction of the specimen, shaped so as to cause pressurized air received at an inlet port in the plenum from a conduit to flow through the hollow channel and exit through the opening between the body and the cap onto the specimen surface at the section; and a flow valve situated in the conduit for controlling the flow of pressurized cooling air through the conduit to the cooling plenum.

In another embodiment according to the invention, an improvement to the cooling apparatus for use in strain-controlled, thermo-mechanical fatigue testing of a specimen is disclosed. The improvement comprises the toroid-like shaped plenum wherein the interior side of the plenum sidewall is shaped so as to substantially conform to the cross-sectional shape of the specimen at the section and, in the direction of the specimen, emulates a curved surface so as to cause pressurized air received at an inlet port in the plenum from a conduit to flow through the hollow channel and exit through the opening between the body and the cap and comprise a fluid jet adhering to the interior side of the plenum sidewall, entraining additional air via the Coanda effect, and directing the fluid jet of pressurized air and entrained air onto the specimen surface at the section.

In another embodiment according to the invention, an improvement to the adjustable heating coil support assembly for use in strain-controlled, thermo-mechanical fatigue testing of a specimen is disclosed as an adjustable heating coil and cooling plenum support assembly. The assembly comprises a heating coil and a cooling plenum each fixedly mounted to a moveable stage assembly that is slideably mounted to a slide affixed parallel to the specimen, and an individual stepper motor mounted to a ball-screw stage affixed to the moveable stage assembly, together with suitable controls. This assembly provides the ability to alter the axial position of the RF induction coil and the cooling plenum by controlled movement with precision and repeatability. The assembly can support up to a three-zone coil configuration (upper and lower coils, plus a middle coil).

In another embodiment according to the invention, an integrated heating coil and cooling apparatus for use in strain-controlled, thermo-mechanical fatigue testing of a specimen is disclosed. The apparatus comprises: a toroid-like shaped plenum; a moveable metallic heating coil comprised of a plurality of windings of a tube for placement within said central bore, such that the heating coil may be located substantially between the top and bottom surfaces of the plenum, surrounding the section of the specimen, the heating coil having an inlet and an outlet comprised of metallic tubing, wherein the inlet includes a first end and the outlet includes a second end, both of which are suitable for connection to a radio frequency induction furnace, wherein the cooling plenum and the heating coil are slideably mounted to a moveable slide-carriage assembly so as to facilitate synchronized movement of the heating coils and the cooling plenum; and a flow valve situated in the conduit for controlling the flow of pressurized cooling air through the conduit to the plenum. The moveable slide-carriage assembly may comprise a dielectric block slideably connected to a slide, which operates along the longitudinal direction of the specimen, and an individual stepper motor mounted to a ball-screw stage affixed to the slide-carriage assembly, together with suitable controls.

In another embodiment according to the invention, the flow valve may comprise a servo-proportional valve.

In yet another embodiment according to the invention, the moveable slide-carriage assembly may also include a sensor, such as an optical sensor, mounted so as to facilitate fine, repeatable positioning of the carriage anywhere along the slide.

In yet another embodiment according to the invention, the heating coils may be comprised of tubing having a substantially square cross section.

In yet another embodiment according to the invention, there is disclosed a method for setting up a thermo-mechanical fatigue test of a specimen. The method comprises: placing first and second heating coils around a specimen together with a cooling plenum; placing the specimen in a load frame suspended between two hydraulic collet grips or similar restraints that provide a constant adjustable gripping force (if the specimen is ceramic, a susceptor must be placed around the specimen or a flux concentrator must be used); placing first and second heating coils transverse to the specimen such that an extremity of each heating coil is positioned at approximately a first and second shoulder of the specimen; adjusting the heating coils about the specimen such that they are generally concentric with the diameter of the specimen; providing a radio frequency induction furnace; bringing the test specimen to test temperature by powering the RF coils; observing temperature readings at first and second ends of specimen gage position and at center of gage position; adjusting overall axial position of the heating coil as a unit such that the temperatures at first and second gage positions reasonably conform to each other; adjusting the spacing between the first and second heating coils along the axis of the specimen such that the temperature at the center of the specimen reasonably corresponds to the temperatures at the first and second specimen gage positions; recording positions of heating coils; proceeding to the next test temperature and repeating the process; repeating the process for each temperature to be tested; and selecting the coil positioning that provides the most favorable thermal gradient for the test.

In yet another embodiment according to the invention, there is disclosed a method for setting up a thermo-mechanical fatigue test of a metal or ceramic specimen with cooling. The method comprises: performing the steps in the preceding paragraph; positioning the cooling plenums such that the central axis of the heating coils and the specimen are generally coaxial with the central axis of a hollow bore of each cooling plenum providing a source of pressurized cooling air.

In yet another embodiment according to the invention, there is disclosed a method for setting up a strain-controlled, thermo-mechanical fatigue test of a ceramic or other non-metallic specimen. The method comprises: surrounding the specimen with a susceptor along the length of the specimen; and then following the steps for setting up a thermo-mechanical fatigue test of a metal specimen, as set forth above. The susceptor may be placed in contact with the specimen, in which case the heating coils will heat the susceptor, which will transfer that heat to the specimen by means of conduction. The susceptor may also be placed about the specimen with an air gap between the susceptor and the specimen, in which case the specimen will be heated by means of infrared thermal radiation from the susceptor. In lieu of a susceptor, a flux concentrator may be mechanically affixed to the heating coil so as to concentrate the magnetic flux from the coil onto the specimen.

### DESCRIPTION OF THE DRAWINGS

FIG. 1 is an illustration of a specimen as machined and after prior art testing, exhibiting the geometric instability that can result from inadequate control of thermal gradients.

FIG. 2 is an illustration of a typical prior art TMF testing fixture.

FIG. 3 is a more advanced version of a prior art TMF testing fixture.

FIG. 4 is an isometric view of a multi-zone prior art fixture for actively controlling test specimen thermal gradients.

FIG. 5 is an illustration of a prior art cooling chamber installed in a load train.

FIG. 6 is an illustration of an adjustable heating coil support assembly (heating coil not shown).

FIG. 7 is a face view of an adjustable heating coil support assembly (heating coil not shown).

FIG. 8 is a side view of an adjustable heating coil support assembly (heating coil not shown).

FIG. 9 is a side view of a cooling plenum

FIG. 10 is a top view of a cooling plenum cap.

FIG. 11 is a section through a cooling plenum cap.

FIG. 12 is a top view of a cooling plenum body.

FIG. 13 is a section through a cooling plenum body

FIG. 14 is a detail of the section of the cooling plenum body.

FIG. 15 is a section through the cooling plenum body.

FIG. 16 is a side view of a cooling plenum and heating coil situated in an adjustable heating coil/cooling plenum support assembly

FIG. 17 is a perspective of a moveable heating and cooling support assembly.

FIG. 17A is a detail of a notch in the strip.

FIG. 18 is a top view of an improved cooling plenum body.

FIG. 19 is a side view of an improved cooling plenum body.

FIG. 20 is a detail of a side view of a cooling plenum body.

FIG. 21 is a detail of the steps in the setup procedure for a TMF test.

FIG. 22 is a side view of a specimen with coils placed around it.

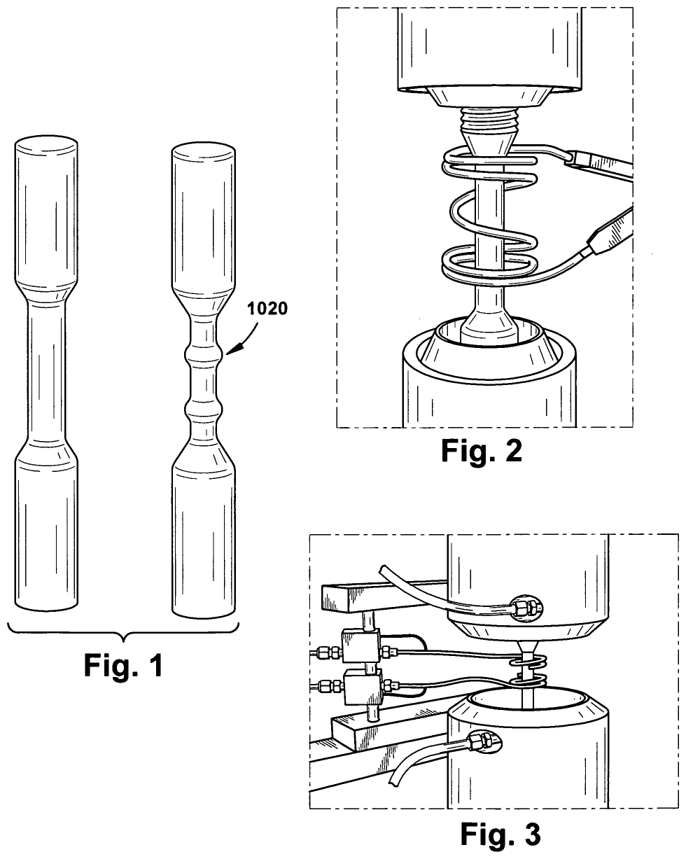

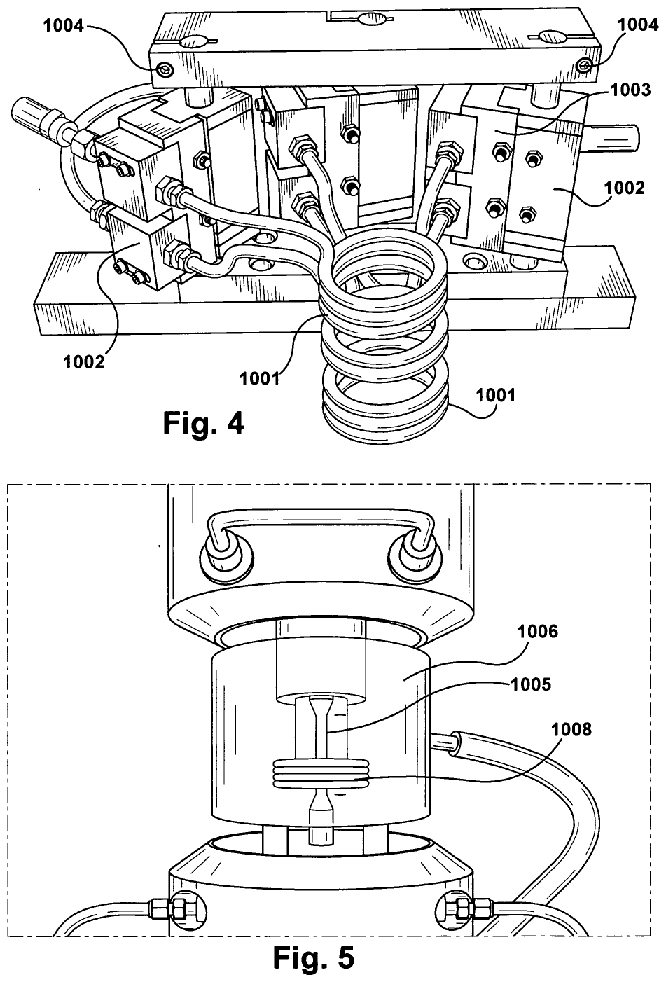

### DETAILED DESCRIPTION OF THE INVENTION

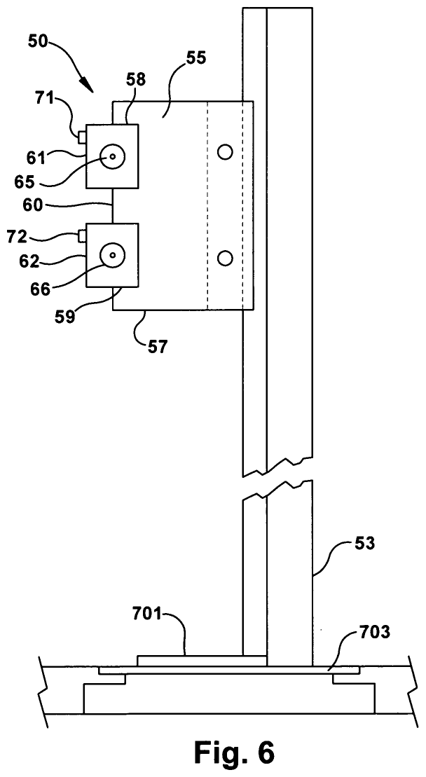

A first embodiment of the present invention will be described hereinafter with reference to the drawings. Referring to FIGS. 6, 6A, 7, and 8, an adjustable radio frequency induction heating coil support assembly 50 is shown for use with a radio frequency induction heating coil (not shown) (hereinafter referred to as a “heating coil”) in a thermal-mechanical testing apparatus. A stepper motor 51 is mounted to a ball screw 52 of a stage assembly 53 via a shaft coupler 54. The stage assembly 53 is basically a slide that permits adjustment of the heating coil (not shown) in the direction of the slide, i.e., along the axis of the specimen, through a moveable stage 57 that is slideably connected to the stage assembly 53. The moveable stage 57 provides a platform to facilitate movement in a direction toward and away from the specimen (not shown) and to hold the heating coil (not shown) firmly in place once the proper placement of the heating coil (not shown) has been attained. Motion in the third direction is provided by the base 701 of the stage assembly 53, which is fixedly attached to a turntable 703 facilitating the movement of the heating coils in an arc, essentially normal to the direction of movement provided by the moveable stage 57 at the specimen (not shown). The stage assembly 53 is preferably an MDrive 17 Linear Slide manufactured by Intelligent Motion Systems, Inc.

The moveable stage 57 includes a dielectric block 55, preferably comprised of a phenolic block, fixedly attached to sides 56A, 56B, preferably also of phenolic material, the combination of which is slideably attached to the stage assembly 53. The dielectric block 55 and sides 56A and 56B may be of unitary construction, such as a milled dielectric block. The moveable stage 57 may be translated along the stage assembly 53 via the ball screw 52, which is driven by the stepper motor 51. The dielectric block 55 and sides 56A and 56B include two elongated slots 58 and 59 milled in a direction normal to the direction of the stage assembly 53 opposite the stage assembly 53, along the first face 60. Two heating coil connection blocks 61 and 62 are slideably mounted into elongated slots 58 and 59. Each heating coil connection block 61, 62 includes a hollow conduit 63, 64 running through the blocks 61, 62 in a direction normal to the stage assembly 53 and parallel to elongated slots 58, 59, and further includes a connection fitting 65, 66 connected to a first end 73 of each conduit 63, 64 for connecting to a lead 67, 68 from a heating coil (not shown) and a connection fitting 69, 70 connected to a second end 74 of each conduit 63, 64 for connection to a lead (not shown) from a radio frequency induction furnace or other type of heating source (not shown). The heating coil connection blocks 61, 62 are preferably comprised of stainless steel. The heating coil connection blocks 61, 62 are fastened to the connection fittings 65, 66 and 69, 70 to facilitate uninterrupted flow, such as by threading the connection fittings 65, 66 and 69, 70 into the heating coil connection blocks 61, 62. Once the heating coil connection blocks 61, 62 are slideably positioned in the elongated slots 58, 59, and an appropriate position for a particular testing apparatus setup has been achieved (as discussed below), the heating coil connection blocks 61, 62 may be fixedly mounted into the dielectric block 55 via thumbscrews (socket head cap screws) 71, 72 or similar fasteners. It is also possible to place both hollow conduits 63, 64 in a single heating coil connection block 61 in a single elongated slot 58, although accuracy of placement of the heating coil may be adversely affected. And the hollow conduits 63, 64 may also be placed on opposite faces of the dielectric block 55 and sides 56A, 56B.

The stepper motor 51 in combination with the ball screw 52 facilitates precise altering of the position of the moveable stage 57 along the stage assembly 53 and thus precise positioning of the heating coil (not shown) both in the direction of the elongated slots 58, 59 attached to the moveable stage 57, and in the direction along the stage assembly 53. Preferably, the combination of the stepper motor 51, ball screw 52, moveable stage 57, and stage assembly 53 should perform controlled movements with extremely fine precision and good repeatability. In lieu of a stepper motor 51, a servomotor may also be capable of providing extremely fine precision and good repeatability. Preferably, the combination of the stepper motor 51, ball screw 52, moveable stage 57, and stage assembly 53 should produce positional accuracy of 0.0001 inch, with bidirectional repeatability of up to 50 micro-inches. Each stepper motor 51 is preferably equipped with a drive (not shown) that permits micro-stepping such that each rotation preferably can be controlled up to a resolution of 1 part in 51,200, with a ball screw lead of 0.1 inch per revolution, and preferably is capable of static holding torque of at least 48 oz.-in.

As shown in FIGS. 6 and 6A, the base 701 of the stage assembly 53 may be fixedly attached by fasteners 702 to a turntable 703, i.e., a thin, flat, circular rotating member, resting on a shelf 725 located in a circular opening 726 in a rigid base 704, sized to accept the turntable 703. The rigid base 704 may be fixedly attached to a rigid object (not shown), such as a base holding the thermo mechanical testing apparatus (not shown). The rigid base 704, including the turntable 703, is preferably made of aluminum. Proximate to the turntable 703 are at least two openings 710, 710A sized and threaded to receive a washer and bolt combination 711, 711A for holding down the turntable 703 while the heating coil 98 is being positioned, and then for tightening against the turntable 703 and the rigid base 704 so as to preclude rotation once the heating coil 98 is in its proper position for testing a specimen 99.

In addition to the combination of a stepper motor 51, ball screw 52, moveable stage 57, and stage assembly 53, other fine adjustment devices with controlled movement, fine precision and good repeatability would also work for adjusting the position of the heating coil. An overall ability to make fine, repeatable adjustments in three independent modes of motion together with an ability to fix in place each of these modes once the proper location has been determined permits a much closer control of temperature gradients than had been available previously. A motor that rotates in small, fixed increments, such as a stepper motor or servomotor is required in order to obtain the fine adjustments needed for proper control of temperature gradients.

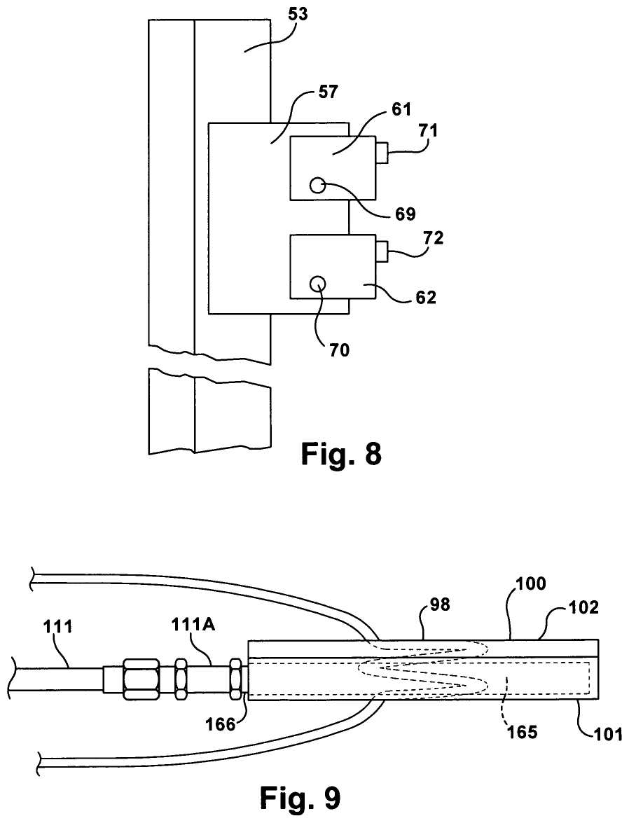

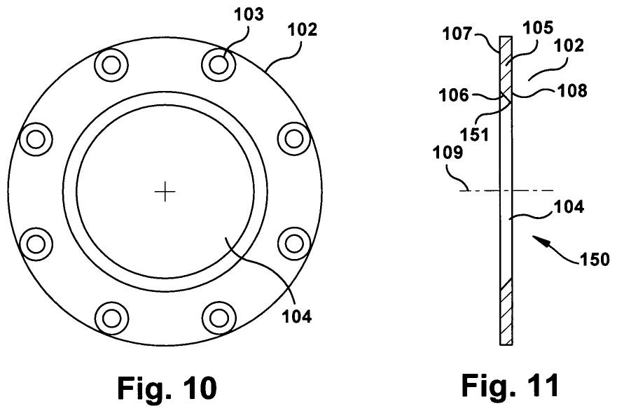

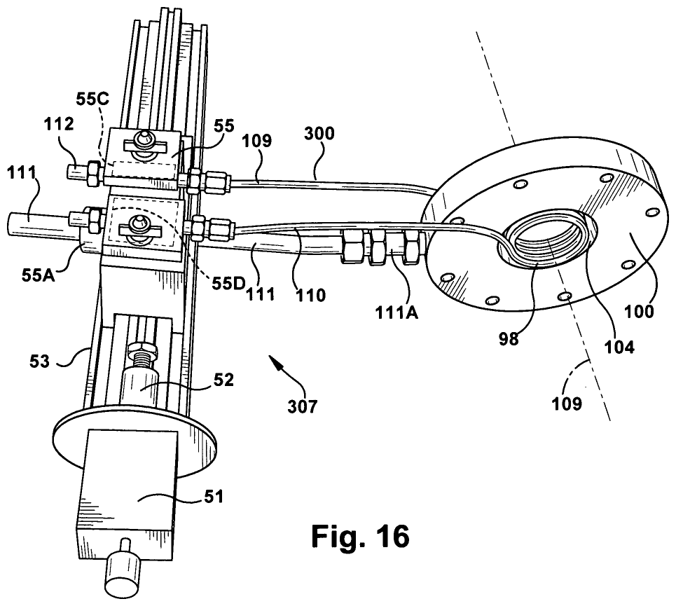

Referring to FIG. 9 through 15, in a second embodiment of the present invention, a side view of a cooling plenum 100 is shown in FIG. 9 for use in a thermal-mechanical testing apparatus (not shown), where the specimen 99 (FIG. 10) would be suspended in tension at the center of the central bore 104 (FIG. 10). Referring to FIG. 9, the cooling plenum is comprised of two pieces, a body 101 (shown in FIGS. 12 through 15) and a cap 102 (shown in FIGS. 10 and 11). Referring to FIGS. 9, 10 and 11, the cap 102 may comprise a relatively flat, thin, generally circular ring, although other shapes could be used, particularly where the shape of the specimen 99 is other than round. The cap 102 may have openings 103 spaced about its periphery sized to accept fasteners so as to fixedly fasten the cap 102 to the body 101. The openings 103 permit the cap 102 to be fixedly fastened to the body 101 by means of bolts or other fasteners passing through the openings 103 into threaded openings 157 spaced about the body 101. Other means may be used to fasten the cap 102 to the body 101, such as clips. The cap 102 contains a central bore 104, which may be sized so as to permit the placement of a test specimen 99 and a heating coil (98 as shown in FIG. 16) within the central bore 104. The central bore 104 may be sized larger than necessary for placement of the test specimen 99 and a heating coil (98 as shown in FIG. 16) within the bore 104, but a larger diameter bore 104 will adversely affect the cooling rate. Likewise, with a larger central bore 104, the heating coil can be wound with larger diameter tubing, but this too will affect heating rates.

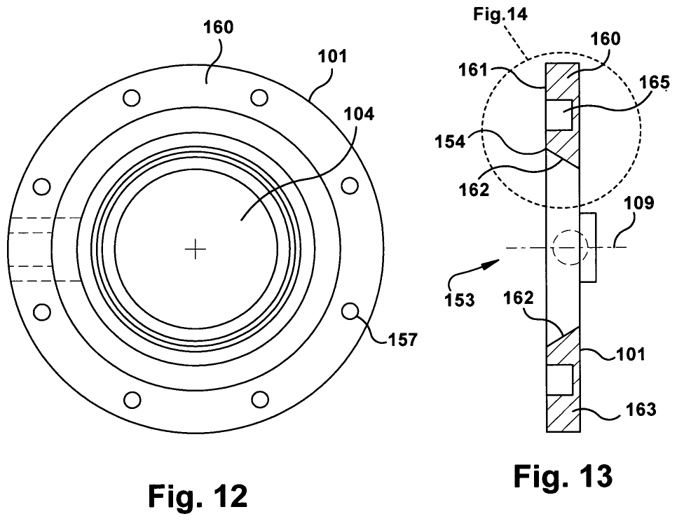

Referring to FIG. 11, the interior surface 106 of sidewall 105 of the cap 102 is cut at an angle from a plane at first surface 107 of the cap 102 sloped inward toward the central axis 109 of cap 102 to second surface 108. The size of the angle is dependent upon the size of the plenum 100 and the diameter of the test specimen 99. Diameter 150 at intersection 151 between second surface 108 and interior surface 106 of cap 102 is equal to diameter 153 at intersection 154 (shown in FIG. 13), such that when the body 101 and the cap 102 are fastened together, they provide a relatively smooth transition from the cap 102 to the body 101 at the central bore 104 of the cooling plenum 100, although a small gap must exist between the cap 102 and the body 101 where they meet at the central bore 104.

Referring to FIG. 12, the body 101 of the cooling plenum 100 also may be a relatively flat, thin circular ring. The body 101 may include openings 157 spaced around the periphery of the body 101 for mating with the openings 103 in the cap 102 and for receiving a bolt or other fastener (not shown) for fastening the cap 102 to the body 101. The interior portion of the body 101 comprises a central bore 104 sized, like the central bore 104 in the cap 102, so as to permit the placement of a specimen 99 and heating coil (98 in FIG. 16) within the central bore 104. Like the central bore 104 in the cap 102, the central bore 104 in the body 101 may be sized with a larger diameter, but it will have an adverse effect on the cooling rate.

Referring to FIGS. 12, 13 and 14, the sidewall 160 of the plenum body 101 includes a continuous hollow channel 165, which runs throughout the periphery of the plenum body 101. The interior surface 162 of the sidewall 160 of the body 101 is cut at an angle from a plane at first surface 161 of the body 101 sloped inward toward the central axis 109 of body 101 to second surface 163 at an angle substantially similar to the angle of interior surface 106 of sidewall 105 in cap 102, so as to form a relatively uniform surface from the intersection of interior surface 106 and surface 107 to the intersection of interior surface 162 and surface 163, while leaving a slight opening at the interface between interior surface 106 and interior surface 162, such that pressurized air which flows into the continuous hollow channel 165 will flow out of the continuous hollow channel 165 at the interface between cap 102 and body 101 where interior surface 106 meets interior surface 162.

Referring to FIGS. 9 and 15, the body 101 includes an input port 166 for receiving cooling air from a pressurized air source (not shown). The input port 166 may be provided with a fitting 111A sized to flowingly connect to tubing 111, preferably comprised of copper, which functions to supply pressurized air from a pressurized air source (not shown) to the hollow channel 165. Both the cap 102 and the body 101 of the cooling plenum 100 are preferably constructed of aluminum alloy, which is a poor coupler to RF induction sources, thereby obviating any problem that might result from the proximity of the cooling plenum 100 to a heating coil 98 located in the central bore 104 of the cooling plenum 100.

When the cap 102 and the body 101 are fastened together, the cooling effect is most pronounced with a space of between one thousandths of an inch (0.002″) and four thousandths of an inch (0.004″) at the interface between the two where interior surface 106 meets interior surface 162, to allow the air to flow from the continuous hollow channel 165 out through the interface where interior surface 106 meets interior surface 162. This may be achieved by the manner in which the body and cap are milled, or spacers or shims may be employed to provide the appropriate space.

The flow of cooling air to the cooling plenum 100 preferably is controlled with a servo proportional valve (not shown), which exhibits smooth and continuous control in the near closed region. A solenoid valve or other type of proportional valve may also be used to control the flow of cooling air.

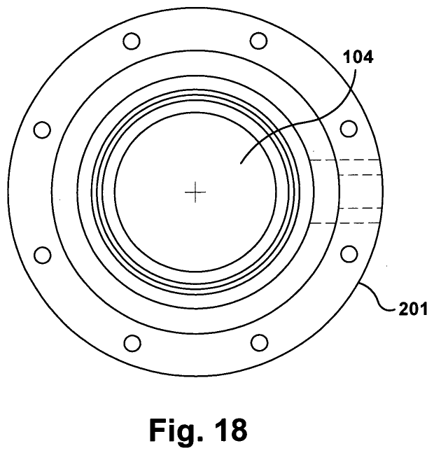

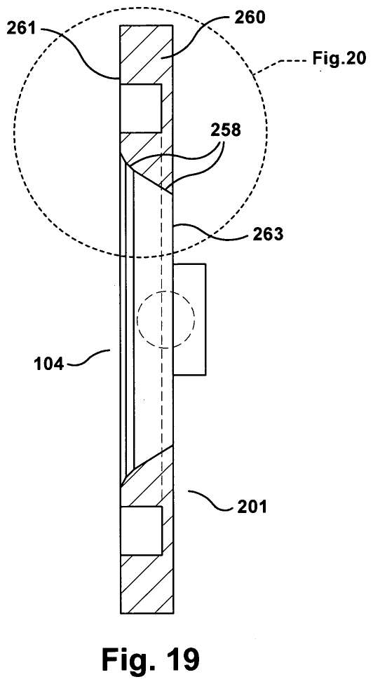

Referring to FIGS. 18, 19 and 20, in another embodiment of the present invention, an improved cooling plenum 200 with improved cooling properties is shown for use in a thermal-mechanical testing apparatus (not shown). In general, the cooling plenum 200 is similar to the cooling plenum 100. The exception to that similarity being that interior surface 262 of the sidewall 260 of the plenum body 201 slopes away from a first surface 261 toward a second surface 263 at increasingly steep angles 270, 271, 272 so as to form an emulated curved surface 258, such that pressurized air may flow out of a continuous hollow channel 265 in the cooling plenum at the interface between the plenum cap 202 and the plenum body 201, and, in accordance with the Coanda effect, be redirected along the emulated curved surface 258 toward second surface 263. As the pressurized air flows along emulated curve surface 258, the flow stream entrains additional air, which becomes part of the flow stream, and then impacts on the entire circumference of a specimen (not shown). The series of angles that must be cut in the body in order to produce the emulated curve may be replaced with an actual curve, but care must be taken to ensure that the curve is neither too steep nor too shallow or the Coanda effect will be lost and the cooling rate will be substantially slower. The same is true in cutting the series of angles 270, 271, 272. It is very important that the resulting curved surface 258 take advantage of the Coanda effect in order to obtain improved cooling.

Other than the improvements discussed in the preceding paragraph, the two cooling plenums discussed herein are the substantially the same.

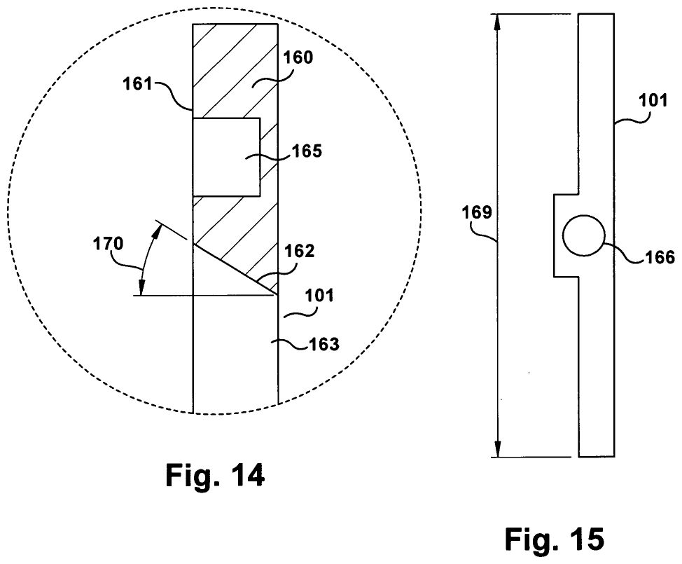

The diameter (169 as shown in FIG. 15) of the cooling plenum 100 or improved cooling plenum 200 is chosen largely based on the overall diameter of the heating coil (98 in FIG. 16), inasmuch as the heating coil diameter cannot be larger than the central bore 104 of the plenum. The angle (170 in FIG. 14) of the interior surface 162 of the sidewall face 165 determines the main point of air impingement on the specimen (99 in FIG. 10) for a given diameter of the central bore 104 of the cooling plenum 100 or improved cooling plenum 200, based upon geometry. In those instances where a cooling plenum milled to take advantage of the Coanda effect is employed, it is not an exact relationship, as the Coanda effect causes additional air to be entrained with the air flowing from the improved cooling plenum 200, and the overall flow field of the air broadens from a simple sheet of revolution about the specimen obtained with the cooling plenum 100.

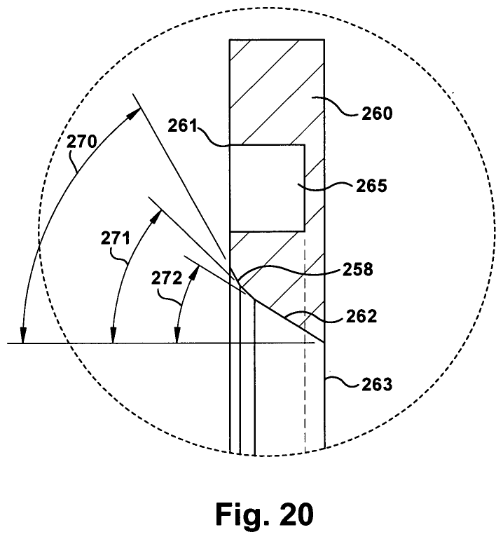

The height of the cooling plenum 100 or improved cooling plenum 200, i.e., the distance between surface 107 and surface 163 in cooling plenum 100, is selected to be as small as possible in order to minimize the obstructions to viewing the specimen during a test and also to permit room for an extensometer (not shown). The limiting factors are the need to deliver compressed air at up to 120 PSI, which effects the strength of the cooling plenum 100 or improved cooling plenum 200 needed for safe operation, and the length of the internal surface (106 plus 162) of the sidewall (105 and 160) needed to initiate the Coanda effect. Below a certain thickness, the Coanda effect is unlikely to arise, as there is not enough length of a body over which the air can flow to induce it. Above a certain size viewing room becomes very cramped. Regarding the plenum angles 270, 271, 272 (in FIG. 20), the principal drivers on the choice of angles are related to optimizing the Coanda effect—too steep of an angle and the Coanda effect will disappear, and determining where the sheet of air impacts the specimen.

Many of the specimens tested today have cross-sections that are round, but not all. In accordance with the invention herein, the central bore 104 of the cooling plenum 100 or improved cooling plenum 200 is intended to conform to the cross sectional shape of the specimen 99, such that there is a generally uniform distance between the specimen 99 and the interior surface (106 plus 162) of the sidewall (105 and 160) around the entire specimen 99.

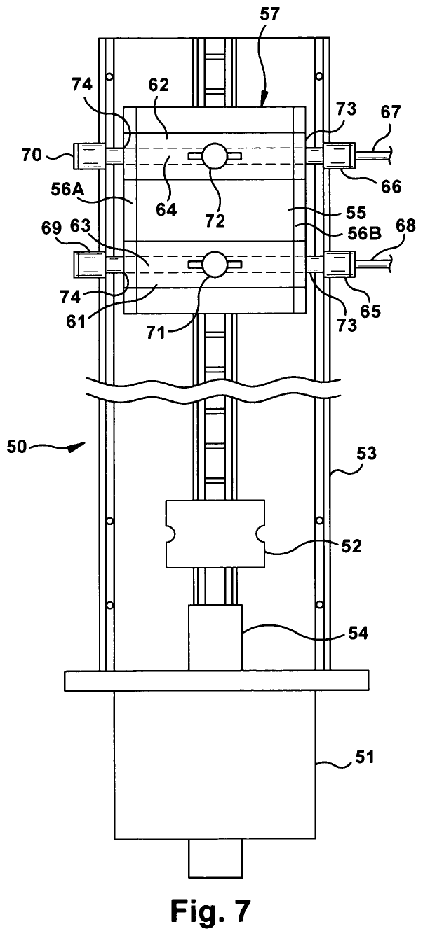

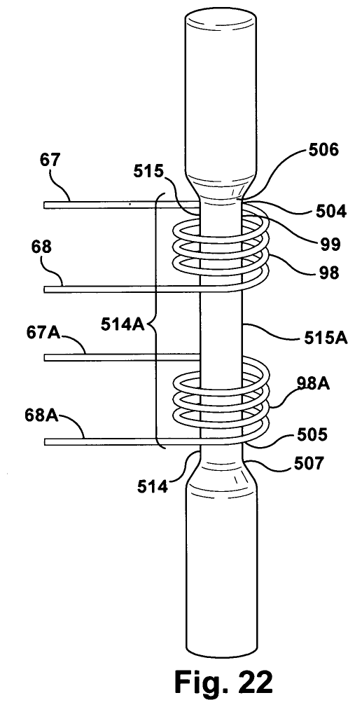

Referring to FIGS. 7, 8, 16, and 17, another embodiment of the present invention, an integrated heating and cooling assembly 307, is shown. A test specimen 99 (shown in FIG. 22) is mounted at first 302 and second 303 ends to a load frame (not shown), which typically employs collet grips (not shown) to hold the specimen in place while it is under tension. The test specimen 99 may be metal or ceramic. If the specimen is ceramic material, it may be heated by radiation from the graphite susceptor (not shown), which is heated by the heating coils 98 or it may be heated through the use of a flux concentrator (not shown).

A heating coil 98 is shown in FIG. 16 within cooling plenum 100 or improved cooling plenum 200. The test specimen (not shown) is centered substantially along the center axis 109 of the central bore 104 of the cooling plenum 100 or improved cooling plenum 200 and the heating coil 98 is centered within the central bore 104 of the cooling plenum 100 or improved cooling plenum 200, such that the test specimen (not shown) is generally mounted along the central axis of both the heating coil 98 and the cooling plenum 100 or improved cooling plenum 200. The leads 109, 110 to the heating coils are connected to the induction furnace (not shown) through the and are preferably comprised of metal tubing.

The diameters of the heating coil 98 and leads 109, 110 are specific to a user's needs. The heating coil 98 tubing diameter controls how many turns per linear length can be made, and therefore, the flux intensity. More flux means greater heating effect. The heating coil 98 tubing diameter also controls how much flux is delivered. As the heating coil 98 tubing diameter increases, the heating efficiency drops, but the temperature uniformity improves. As the heating coil 98 tubing diameter decreases, approaching the outer diameter of the specimen, heating efficiency increases, but the temperature uniformity degrades. If the heating coil 98 is too close to the specimen, it is not possible to keep the coil material cool enough. Maximum flux for heating purposes is delivered to the specimen 99 using tubing with a diameter of one-eighth inch, because it allows the largest number of turns per linear length of specimen. While round section tubing is most readily available and thus may be the tubing of choice, square section tubing enhances the flux patterns, improving heating efficiency, and thus is preferable.

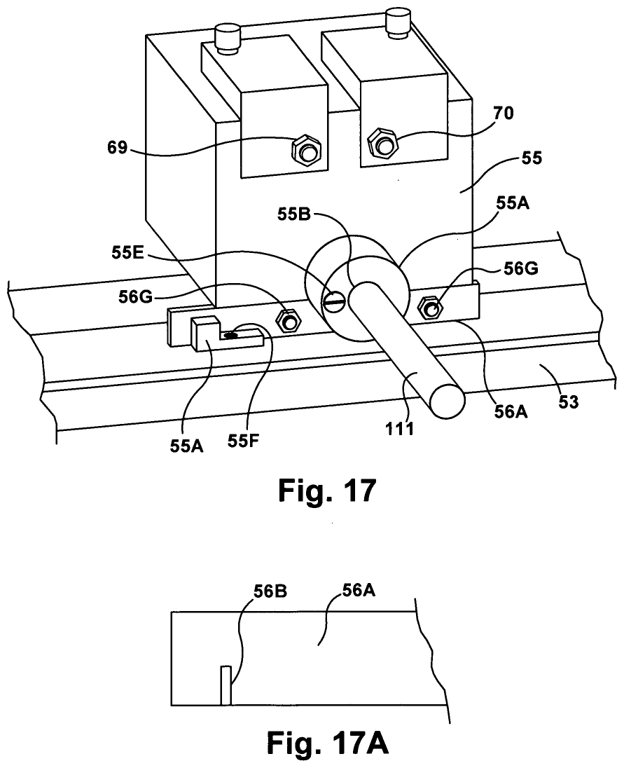

The heating coil 98 is mounted to the dielectric block 55 as described in connection with FIGS. 6, 7 and 8. The heating coil/cooling assembly 307 is moveable along the stage assembly 53, which generally runs parallel to the specimen 99, by a combination of a stepper motor 51, ball screw 52, moveable stage 57, and stage assembly 53, as discussed hereinabove as part of the adjustable heating coil support assembly 50. When set up to run a test, the stage assembly 53 is parallel to the specimen 99, while the tube 111 supplying cooling air to the cooling plenum 100 or improved cooling plenum 200 and the tubes 109, 110 connecting to the heating coil 98 run substantially normal to both the stage assembly 53 and the specimen 99. The dielectric block 55 provides galvanic isolation from the load frame, which minimizes RF arcing. The cooling plenum 100 or improved cooling plenum 200 is fixedly connected to a tube arm 111, preferably ¼″ copper tubing, which runs through the dielectric block 55, and is fixedly attached to the block 55 with a clamp 55A to lock the tube arm 111 in the proper position such that the cooling plenum 100 or improved cooling plenum 200 is concentric with the heating coil 98 and concentric with and normal to the specimen 99. The clamp 55A is preferably made of hard plastic. As shown in FIG. 17, the cross section of the clamp 55A is round or donut shaped with a hollow central bore 55B sized to be approximately equal to the outer diameter of the tube 111. The outer diameter of the clamp 55A is essentially circular with a portion 55C having threads permitting the clamp 55A to screw into a setback 55D in the dielectric block 55 threaded and sized to accept the portion 55C of the clamp 55A. When the clamp 55A is sufficiently tightened, and the cooling plenum 100 is set up as set forth above, a screw 55E, such as a cap screw, may be screwed through the clamp 55A and tight against the block 55 so as to prevent movement of the clamp 55A and hence the cooling plenum 100 or the improved cooling plenum 200.

Thus, both the cooling plenum 100 and the improved cooling plenum 200 may be positioned together with the heating coil 98, and because the tube arm 111 goes through the dielectric block 55, it is electrically isolated. The cooling air supply is attached to the end of the copper tube arm 111 that emerges from the back of the dielectric block 55, and which is attached via clamp 55A and screw 55E. Preferably, the cooling air supply is fed via a flexible hose (not shown) to allow free movement of the cooling plenum 100 or improved cooling plenum 200 with respect to the cooling air supply.

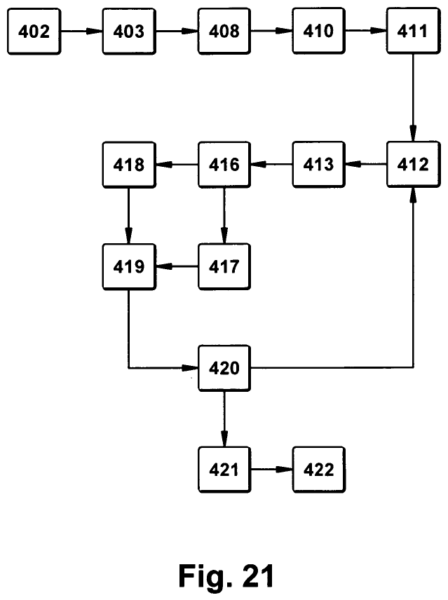

In the embodiment of FIG. 17, a dielectric block 55 on a stage assembly 53 is shown together with connection fittings 69, 70 for connection to a lead from a radio frequency induction furnace or other type of heating source, and a tube arm 111 for attachment to a cooling air supply (not shown). Also shown is an optical sensor 55A moveably secured to the stage assembly 53 such that the optical sensor 55A may be moved along the stage assembly 53 parallel to the movement of the dielectric block 55 along the stage assembly 53 and positioned with a screw 55F or similar fastener to the stage assembly 53 when the dielectric block 55 is placed its final position. The dielectric block 55 is moved along the stage assembly 53 until the heating coil/cooling assembly is properly positioned around the specimen such that the heating coils 98 and cooling plenum 100 or improved cooling plenum 200 are coaxial with the specimen and are properly positioned along the length of the specimen as explained below in connection with FIGS. 21 and 22. A strip 56A is shown fixedly attached to the dielectric block 55 with screws 56G or similar fasteners. The strip 56A contains a notch 56B, as shown in FIG. 17A, sized to permit the optical sensor 55A to shine through the notch without occlusion when the optical sensor 55A and the dielectric block 55 with strip 56A are moveably attached to the stage assembly 53. After fixedly attaching the cooling plenum 100 or improved cooling plenum 200, and the heating coils 98 in place for conducting a test, and prior to fixedly attaching the optical sensor 55A to the stage assembly 53, the optical sensor 55A is moved along the stage assembly 53 parallel to the dielectric block 55 until the optical sensor 55A shines through the notch 56B and is not occluded by the strip 56A. At that point, the optical sensor 55A is fixed in place with a screw 55F or similar type of fastener, and the dielectric block 55, and hence the heating coil 98/cooling plenum (100 or 200) assembly, can be returned to the proper test setup position by moving the dielectric block 55 to the point where the optical sensor 55A is not occluded by the strip 56A. The strip 56A may be made of plastic, heavy paper, or a metal.

In the embodiment of FIGS. 21 and 22, a method of setting up the integrated heating coil and cooling ring assembly 300, which may include either a cooling plenum 100 or an improved cooling plenum 200, for a strain-controlled thermo-mechanical fatigue test of a specimen is disclosed. The same method may be used for setting up just an integrated heating coil 98 assembly by just deleting the steps relating to adjusting the cooling plenum 100 or improved cooling plenum 200. The method comprises a first step 402, in which a lab assistant places an integrated heating coil and cooling assembly 300 around a metal specimen 99 and mounts the specimen 99 in a load frame suspended between two hydraulic collet grips or similar restraints, which provide a constant adjustable tensile force. In step 403 the lab assistant situates first and second heating coils 98 and 98A around the specimen 99 in such a way that the first extremity 504 of heating coil 98 is positioned at first shoulder 506 of specimen 99 and the second extremity 505 of heating coil 98A is positioned at second shoulder 507 of specimen 99. In step 408, if a third heating coil (not shown) is required for the test, the lab assistant places a third heating coil (not shown) around the specimen 99 prior to mounting the specimen 99 in the load frame, such that it is positioned equidistant between the first and second heating coils 98 and 98A. In step 410 the lab assistant adjusts each of the heating coils 98, 98A about the specimen 99, such that they are generally concentric with the specimen 99. This is done by adjusting the heating coil connection blocks 61, 62 mounted in the elongated slots 58, 59 in the dielectric block 55, the position of the turntable 703 on the rigid base 704, and the position of the moveable stage 53 along the stage assembly 57 until the proper position of concentricity with the specimen, the heating coils and the cooling plenum 100 or improved cooling plenum 200 are found and the heating coils 98, 98A are in their proper position for heating the specimen as set forth above. At that point, the heating coil connection blocks 61, 62 are fixed in the elongated slots 58, 59, by tightening thumbscrews 71, 72, the position of the turntable 703 is fixed on the rigid base 704 by tightening bolt and washer combination 711, and the position of the moveable stage 57 is fixed along the stage assembly 53. In this way, the heating coils 98, 98A should provide equivalent heating to the full circumference of the specimen 99. In step 411 the lab assistant connects the heating coils 98, 98A to a radio frequency induction furnace (not shown) through leads 67, 68 and 67A, 68A. In step 412 the lab assistant powers the RF heating coils 98, 98A, and brings the specimen 99 to a first test temperature.

In step 413 the lab assistant observes temperature readings at first and second gage positions 514, 515, i.e., at the outer edges of the section 514A of the specimen 99 that is being tested, i.e., the portion of the specimen on which the actual test will be conducted, and at the center gage position 515A, i.e., the midpoint between gage positions 514 and 515 along the test section 514A. The temperature readings may be obtained from thermocouples, an optical pyrometer, or a thermal imager (none of which are shown, but with which persons of skill in the art of thermal-mechanical testing apparatus will be familiar). In step 416, the lab assistant adjusts the overall axial position of the heating coils 98, 98A, such that the temperatures at first and second gage positions 514, 515 reasonably conform to each other. Upon making this adjustment, the temperature readings will likely show that the temperatures at the first and second gage positions 514, 515 will be either greater or less than the reading at the center of the gage length. If greater, heating coils 98 and 98A are too far apart and must be moved closer together along the axis of the specimen 99, by moving the moveable stage 57 along the stage assembly 53 employing the stepper motor 51. If less, heating coils 98 and 98A are too close together and must be moved further apart, again by moving the moveable stage 57 along the stage assembly 53 employing the stepper motor 51. In step 417, the lab assistant adjusts heating coils 98 and 98A so that they are closer together along the axis of the specimen 99. In step 418, the lab assistant adjusts heating coils 98 and 98A so that they are further apart. All such adjustments of the heating coils are made with the integrated adjustable heating coil 98/cooling plenum 100 (or 200) support assembly 53, which includes a stepper motor 51/ball screw 52/moveable stage 57/stage assembly 53 arrangement, as discussed above.

The purpose of the adjustments is to arrange spacing between the heating coils 98, 98A and a third heating coil (if used), such that the temperatures at the first and second gage positions 514 and 515 and the temperature at the center point of the gage position 515A reasonably conform to one another. This may take several repetitions until the temperatures reasonably conform. In step 419, the lab assistant records the positions of the heating coils 98, 98A, and a third heating coil (if used) for the test temperature, employing the method described above in connection with FIGS. 17 and 17A, using an optical sensor 55A, a strip 56A, and a notch 56B. In step 420, the lab assistant determines whether there are additional temperatures at which the specimen 99 is to be tested. If there are, the lab assistant returns to step 412. If there are not, the lab assistant may then move to step 421, in which the lab assistant positions the heating coils 98, 98A, and a third heating coil (if used) in the positions recorded at step 419 for the first test temperature. In step 422, the lab assistant provides a source of pressurized air, connects the pressurized air to the cooling plenum 100 or improved cooling plenum 200, and powers up the RF heating coils 98, 98A, and a third heating coil (if used).

While the foregoing has described what is considered to be the best mode and, where appropriate, other modes of performing the invention, the invention should not be limited to specific apparatus configurations or method steps disclosed in this description of the preferred embodiment. Those skilled in the art will also recognize that the invention has a broad range of applications, and that the embodiments admit of a wide range of modifications without departing from the inventive concepts.

I claim:

1. A cooling plenum assembly for use in a strain-controlled thermo-mechanical fatigue test of a specimen, wherein the specimen is suspended in a load frame under a constant tensile force, the cooling plenum assembly comprising:
a relatively thin, flat toroid-like shaped plenum having a cap fixedly connected to a body, a hollow central bore, and a perimeter sidewall surrounding the hollow central bore;
wherein the hollow central bore is shaped such that the plenum may surround the specimen, normal to the specimen, while the specimen is suspended, and a first perimeter shape of the hollow central bore substantially conforms to a second perimeter shape of the specimen;
a continuous hollow channel within said perimeter sidewall;
a continuous opening of between 0.002 and 0.004 inches between the cap and the body on an interior side of said perimeter sidewall;
an inlet port in the perimeter sidewall fixedly connected to a conduit operational to carry pressurized cooling air; and
wherein the inlet port flowingly connects to the continuous hollow channel in said perimeter sidewall such that the pressurized cooling air may flow through the conduit, through the inlet port, through the hollow channel, and out the plenum through the continuous opening on the interior side of said perimeter sidewall.

2. An improved cooling plenum assembly for use in a strain-controlled thermo-mechanical fatigue test of a specimen, wherein the specimen is suspended in a load frame under a constant tensile force, the improved cooling plenum comprising:
the cooling plenum assembly of claim 1, wherein the interior side of the plenum sidewall provides a surface sufficiently curved as to cause pressurized air exiting through the continuous opening between the body and the cap to adhere to the interior side of the plenum sidewall, entraining additional air, and be directed as a fluid jet of pressurized air and entrained air onto a surface of the specimen.

3. An adjustable radio frequency induction heating coil assembly for use in a strain-controlled thermo-mechanical fatigue test of a specimen, wherein the specimen is suspended in a load frame under a constant tensile force, the adjustable radio frequency induction heating coil assembly comprising:
a radio frequency induction heating coil comprised of a plurality of windings of a metal tube for placement around the specimen, the radio frequency induction heating coil having a first end and a second end, each comprised of metallic tubing suitable for connection to a radio frequency induction furnace through a connection fitting;
a moveable stage slideably connected to a stage assembly, the moveable stage comprising:
a dielectric block having at least one elongated slot in a first face;
a heating coil connection block slideably connected to the dielectric block in the elongated slot, having a hollow conduit through the heating coil connection block and a connection fitting fixedly attached at first and second ends of the hollow conduit;
wherein the moveable stage is moveably connected to a motor rotating in small, fixed increments; and
a turntable fixedly attached to a base of the stage assembly, the turntable in rotatable connection with a rigid base.

4. An integrated radio frequency induction heating coil and cooling plenum assembly for use in a strain-controlled thermo-mechanical fatigue test of a specimen, wherein the specimen is suspended in a load frame under a constant tensile force, the integrated radio frequency induction heating coil and cooling plenum assembly comprising:
the cooling plenum assembly of claim 1;
the adjustable radio frequency induction heating coil assembly of claim 3;
wherein a substantial part of the radio frequency induction heating coil may be located between first and second outer planes of the cooling plenum, surrounding a section of the specimen.

5. An improved integrated radio frequency induction heating coil and cooling plenum assembly for use in a strain-controlled thermo-mechanical fatigue test of a specimen, wherein the specimen is suspended in a load frame under a constant tensile force, the improved integrated radio frequency induction heating coil and cooling plenum assembly comprising:
the improved cooling plenum assembly of claim 2;
the adjustable radio frequency induction heating coil assembly of claim 3;
wherein a substantial part of the radio frequency induction heating coil may be located between first and second outer planes of the improved cooling plenum, surrounding a section of the specimen.

6. The integrated radio frequency induction heating coil and cooling plenum assembly of claim 4, wherein the specimen is made of at least one of a metal or a ceramic with a graphite susceptor.

7. The improved integrated radio frequency induction heating coil and cooling plenum assembly of claim 5, wherein the specimen is made of at least one of a metal or a ceramic with a graphite susceptor.

8. The integrated radio frequency induction heating coil and cooling plenum assembly of claim 4, wherein the tubing has a substantially square cross section.

9. The improved integrated radio frequency induction heating coil and cooling plenum assembly of claim 5, wherein the tubing has a substantially square cross section.

10. The integrated radio frequency induction heating coil and cooling plenum assembly of claim 4, wherein the motor rotating in small, fixed increments may exert a static holding torque of at least 48 ounce-inches.

11. The improved integrated radio frequency induction heating coil and cooling plenum assembly of claim 5, wherein the motor rotating in small, fixed increments may exert a static holding torque of at least 48 ounce-inches.

12. A method of setting up the integrated radio frequency induction heating coil and cooling assembly of claim 4 for conducting a strain-controlled thermo-mechanical fatigue test of a specimen comprising the steps of:
placing the integrated radio frequency induction heating coil and cooling plenum assembly of claim 1 around a specimen;
placing the specimen in a load frame suspended between hydraulic collet grips so as to provide a constant adjustable tensile force;
positioning the first and second radio frequency induction heating coils of assembly of claim 1 around the specimen in such a way that a first extremity of the first radio frequency induction heating coil is positioned at a first shoulder of the specimen and a second extremity of the second radio frequency induction heating coil is positioned at a second shoulder of the specimen and the first and second radio frequency induction heating coils are generally concentric with the specimen;
connecting the first and second radio frequency induction heating coils to a radio frequency induction furnace;
powering the first and second radio frequency induction heating coils via the radio frequency induction furnace and bringing the specimen to a first test temperature.
observing a temperature of the specimen at a first gage position, a second gage position, and a midpoint on the specimen between the first and second gage position;
adjusting the first radio frequency induction heating coil at the first gage position along the specimen and the second radio frequency induction heating coil at the second gage position along the specimen such that the temperature at the first gage position and the temperature at the second gage position of the specimen reasonably conform;
adjusting the first and second radio frequency induction heating coils closer together or further apart along the specimen such that the temperatures at the first and second gage positions and the temperature at the center gage position reasonably conform;
locking the first and second radio frequency induction heating coils in place;
recording a first position for the first radio frequency induction heating coil and a second position for the second radio frequency induction heating coil for the first test temperature, such that the first and second radio frequency induction heating coils may be accurately returned to their respective first and second positions;
positioning the cooling plenum assembly of claim 1 such that central bore of the cooling plenum assembly of claim 1 is generally coaxial with the first and second heating coils and the specimen;
locking the cooling plenum assembly of claim 1 in place;
providing a source of pressurized cooling air; and
connecting the source of pressurized cooling air to the cooling plenum assembly of claim 1.

13. The method of claim 12, wherein the specimen is comprised of at least one of a metal or a ceramic with a graphite susceptor.
